(19) United States
(12) Patent Application Publication
(10) Pub. No.: US 2003/0164195 A1
(43) Pub. Date: Sep. 4, 2003

(54) Manually operated tank valve

(76) Inventors: Erick Girouard, Guelph (CA); Derek Jean, Waterloo (CA); David McDivitt, Ancaster (CA)

Correspondence Address: VALENTINE A. COTTRILL, SUITE 1020 50 QUEEN STREET NORTH, KITCHENER, ON, N2H6M2, CA

(21) Appl. No.: 10/085,109

(22) Filed: Mar. 1, 2002

(51) Int. Cl. F16K 11/14

(52) U.S. Cl. 137/871

(57) ABSTRACT

The present invention provides a valve apparatus comprising a conduit, including a first port, a second port, and a third port, a piston sealingly disposed within the conduit, including a first piston aperture and a second piston aperture, a piston valve configured to seal the second port, and a bore, extending from the first piston aperture to the second piston aperture, and configured to facilitate communication between the first port and the second port, and a valve, disposed within the conduit, and configured to seal the third port. The present invention further provides a valve apparatus comprising, a conduit, including a first port, a second port, a third port, a first sealing surface disposed between the first port and the second port, and a second sealing surface disposed between the second port and the third port, a piston sealingly disposed within the conduit, including a first piston aperture and a second piston aperture, a first piston valve surface configured to seal the first sealing surface, a second piston valve surface configured to seal the second sealing surface, and a bore, extending from the first piston aperture to the second piston aperture, and configured to facilitate communication between the first port and the third port, and a valve, disposed within the conduit, and configured to seal the second piston aperture to thereby seal the third port. The present invention further provides a valve apparatus comprising a conduit, including a first port, a second port, a third port, and a radially extending shoulder, a piston sealingly disposed within the conduit, including a first piston aperture and a second piston aperture, a piston valve configured to seal the second port, and a bore, extending from the first piston aperture to the second piston aperture and configured to facilitate communication between the first port and the third port, a valve, disposed within the conduit, and configured to seal the third port, and a resilient member, urging the piston to a position whereby the second port is unsealed.

### FIELD OF INVENTION

This invention relates to tank valves, and particularly to tank valves providing positive isolation of pressure vessels.

### BACKGROUND OF THE INVENTION

Manually operated valves are known and used for providing positive isolation of pressure vessels. However, known manually operated valves are typically designed to control flow between two ports. Further components are typically required to achieve additional flow control function.

### SUMMARY OF THE INVENTION

The present invention provides a valve apparatus comprising a conduit, including a first port, a second port, and a third port, a piston sealingly disposed within the conduit, including a first piston aperture and a second piston aperture, a piston valve configured to seal the second port, and a bore, extending from the first piston aperture to the second piston aperture, and configured to facilitate communication between the first port and the second port, and a valve, disposed within the conduit, and configured to seal the third port.

The present invention additionally provides a valve apparatus comprising a conduit, including a first port, a second port, a third port, a first sealing surface disposed between the first port and the second port, and a second sealing surface disposed between the second port and the third port, a piston sealingly disposed within the conduit, including a first piston aperture and a second piston aperture, a first piston valve surface configured to seal the first sealing surface, a second piston valve surface configured to seal the second sealing surface, and a bore, extending from the first piston aperture to the second piston aperture, and configured to facilitate communication between the first port and the third port, and a valve, disposed within the conduit, and configured to seal the second piston aperture to thereby seal the third port.

The present invention further provides a valve apparatus comprising a conduit, including a first port, a second port, a third port, and a radially extending shoulder, a piston sealingly disposed within the conduit, including a first piston aperture and a second piston aperture, a piston valve configured to seal the second port, and a bore, extending from the first piston aperture to the second piston aperture and configured to facilitate communication between the first port and the third port, a valve, disposed within the conduit, and configured to seal the third port, and a resilient member, urging the piston to a position whereby the second port is unsealed.

In one aspect, the piston is sealingly disposed between (i) the first and second ports, and (ii) the third port.

In another aspect, the bore communicates with the first port.

In yet another aspect, the first aperture communicates with the first port.

In a further aspect, the piston is moveable, relative to the conduit, from a first piston position to a second piston position, and wherein the first port is isolated from the second port when the piston is in the first piston position, and wherein the first port is in communication with the second port when the piston is in the second piston position.

In another aspect, the first port is isolated from the third port when (i) the piston is in the second piston position, and (ii) the valve seals the second piston aperture.

In yet a further aspect, the valve is moveable, relative to the conduit, from a first valve position to a second valve position, and wherein the piston is maintained in the first piston position when the valve is in the first valve position, and wherein the piston is moveable from a first piston position when the valve is in the second valve position.

In another aspect, the piston is moveable between a first piston position and a second piston position when the valve is in the second valve position.

In another aspect, the first port is in communication with the third port via the bore when (i) the piston is in the first piston position, and (ii) the valve is in the second valve position.

In yet another aspect, the first port is isolated from the third port when (i) the piston is in the first piston position, and (ii) the valve is in the first valve position.

In a further aspect, the valve retains the piston in the first piston position when the valve is in the first valve position.

In yet a further aspect, the valve is engaged to the piston when (i) the piston is in the first piston position, and (ii) the valve is in the first valve position.

In another aspect, the first port is in communication with the second port, and the first and second ports are isolated from the third port, when (i) the piston is in the second piston position, and (ii) the valve is in the second valve position.

In another aspect, where the conduit includes a first sealing surface, the first sealing surface comprises a valve seat including an orifice, wherein the first port extends into the orifice.

In another aspect, where the piston includes first and second piston surfaces, and where the conduit includes first and second sealing surfaces, the piston is moveable, relative to the conduit, from a first piston position to a second piston position, and wherein the first piston valve surface is sealingly engaged to the valve seat and the second piston valve is sealingly engaged to the second sealing surface when the piston is in the first piston position, and wherein the first piston valve surface is spaced apart from the valve seat and the second piston valve surface is sealingly engaged to the second sealing surface when the piston is in the second piston position.

### BRIEF DESCRIPTION OF DRAWINGS

The invention will be better understood when consideration is given to the following detailed description thereof. Such description makes reference to the annexed drawings wherein:

FIG. 1 is a sectional elevation view of an embodiment of the present invention in a closed condition;

FIG. 2 is a sectional elevation view of an embodiment of FIG. 1 in a fill condition; and

FIG. 3 is a sectional elevation view of an embodiment of FIG. 1 in a supply condition.

### DETAILED DESCRIPTION

The present invention provides a valve apparatus 10 comprising a conduit 12, a piston 14, and a valve 16. The conduit 12 includes a first port 18, a second port 20, a third port 22, a first sealing surface 24, and a second sealing surface 26. The first sealing surface 24 is disposed between the first port 18 and the second port 20. The second sealing surface 26 is disposed between the second port 20 and the third port 22.

The piston 14 is sealingly disposed within the conduit 12, and includes a first piston aperture 28, a second piston aperture 30, a piston valve 32, and a bore 34. A sealing surface or valve seat 31 is disposed peripherally of the second aperture 30. The piston valve 32 is configured to seal the second port 20. The bore 34 extends from the first piston aperture 28 to the second piston aperture 30, and is configured to facilitate communication between the first port 18 and the third port 22. In this respect, the first aperture 28 and, therefore, the bore 34, communicates with the first port 18.

The valve 16 is disposed within the conduit 12. The valve 16 is further configured to seal the third port 22.

In one embodiment, the valve 16 is a manually operated valve including a stem 36 and a plunger 38. The stem36 extends through an aperture 40 formed in the conduit wall 42 to the exterior of the conduit12 to facilitate manipulation thereof. The stem 36 is sealingly engaged to and is received within the aperture 40 for axial movement therethrough. The plunger 38 is configured to seal the second piston aperture 30 by seating against valve seat 31, thereby interrupting flow through the bore 34 between the first and third ports 18, 22.

In one embodiment, the piston valve 32 includes a first piston valve surface 42 and a second piston valve surface 44. Cooperatively, the conduit 14 includes the first sealing surface 24 and the second sealing surface 26. The first sealing surface 24 is disposed between the first port 18 and the second port 20. The first piston valve surface 42 is configured to sealingly engage the first sealing surface 24. In one aspect, the first sealing surface 24 comprises a valve seat 50 including an orifice 52, wherein the first port 18 extends into the orifice 52. The second sealing surface 26 is disposed between the second port 20 and the third port 22. The second piston valve surface 44 is configured to seal the second sealing surface 26. In this respect, the piston 14 is sealingly disposed between (i) the first and second ports 18, 20, and (ii) the third port 22.

In one embodiment, the valve apparatus 10 further includes a resilient member 54, urging the piston 14 to a position whereby the second port 20 is unsealed to thereby effect communication between the first and second ports 18, 20. In this respect, the piston valve 32 is biassed away from the valve seat 50. The resilient member 54 can include a first end 56 and a second end 58, wherein the first end 56 is supported by a shoulder 60 provided in the conduit 12, and wherein the second end 58 is supported by the piston 14. In one aspect, the shoulder 60 is disposed, with respect to the second port 20, remote from the first port 18. Further, the shoulder 60 is disposed between the second and third ports 20, 22.

Where the piston valve 32 includes a first piston valve surface 42 and a second piston valve surface 44, in one embodiment, the second end 58 of the resilient member 54 is supported by the second piston valve surface 44. In one embodiment, the second piston valve surface 44 comprises a first retainer 62, a second retainer 64 and a deformable member 66. The deformable member 66 is disposed between the first retainer 62 and the second retainer 64. In one embodiment, the first and second retainers 62, 64 are snap rings. In one embodiment, the deformable member 66 comprises a first metallic ring 68, a second metallic ring 70, an O-ring 72, a first back-up O-ring 74, and a second back-up O-ring 76. Each of the O-ring 72, first back-up O-ring 74, and second back-up O-ring 76 is disposed between the first metallic ring 68 and the second metallic ring 70. Further, the O-ring 72 is disposed between the first back-up O-ring 74 and the second back-up O-ring 76.

O-ring 72 provides the necessary sealing function between the piston 14 and the conduit 12. Back-up O-rings 74, 76 prevent extrusion of O-ring 72 at high pressures, and the metallic rings 68, 70 support the back-up O-rings 74, 76. In one embodiment, each of the back-up O-rings 74, 76 are configured to be slightly deformable and comprise a relatively hard plastic, such as nitrile. In one embodiment, the metallic ring comprises steel.

In one embodiment, the apparatus 10 is installed within the nozzle 78 of a vessel 80 containing pressurized gas. In this respect, the first port 18 is coupled to the nozzle 78 of the vessel 80 and, therefore, functions as a supply port. The second port 20 is coupled to downstream process piping configured to receive pressurized gas from within the vessel 80 to facilitate further processing thereof downstream of the vessel 80. In one embodiment, the second port 20 is coupled to the inlet 82 of a pressure regulator 84 and, therefore, functions as a regulator port. The third port 22 is coupled to a fill assembly 86 configured for intermittent filling of the vessel 80 with pressurized gas and, therefore, functions as a fill port. Operation of the apparatus 10 will now be described with reference to its installation in the vessel 80.

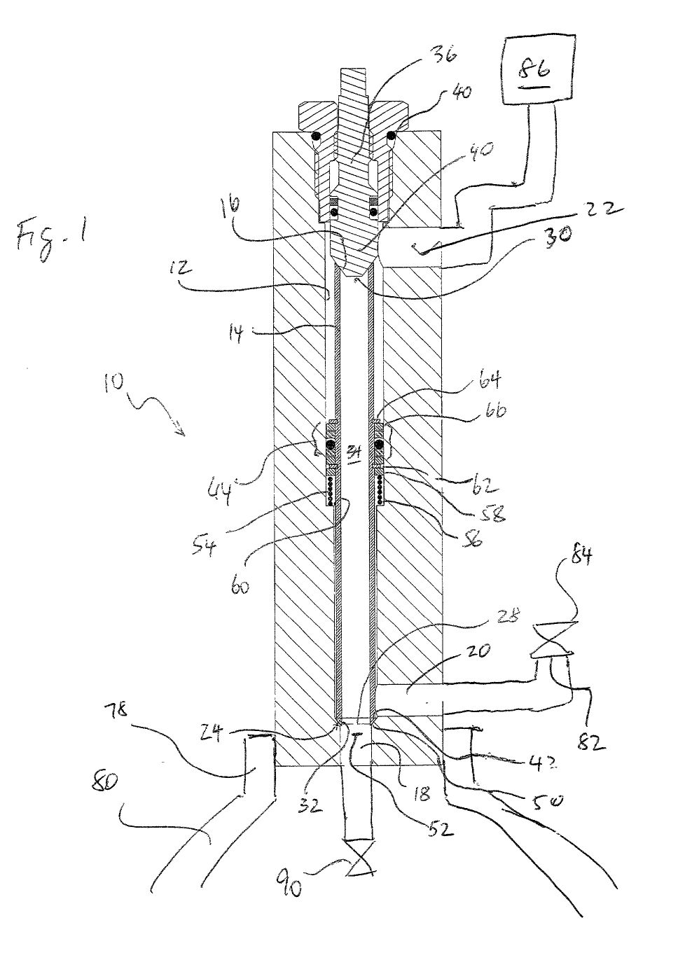

FIG. 1 illustrates the apparatus 10 in a closed condition. In this condition, the first port 18 is isolated from each of the second and third ports 20, 22. The piston 14 is in a first piston position whereby the first port 18 is isolated from the second port 20. In this respect, the first piston valve surface 42 is sealingly engaged to the first sealing surface 46 or the valve seat 50. Likewise, the valve 16 is in a first valve position, whereby the piston 14 is maintained in the first piston position by the valve 16. In this respect, the valve 16 retains the piston 14 in the first piston position by engaging the piston 14 and sealing the second piston aperture 30. Also, the second piston valve surface 44 is sealingly engaged to the second sealing surface 48. As a result, the third port 22 is isolated from each of the first and second ports 20, 22.

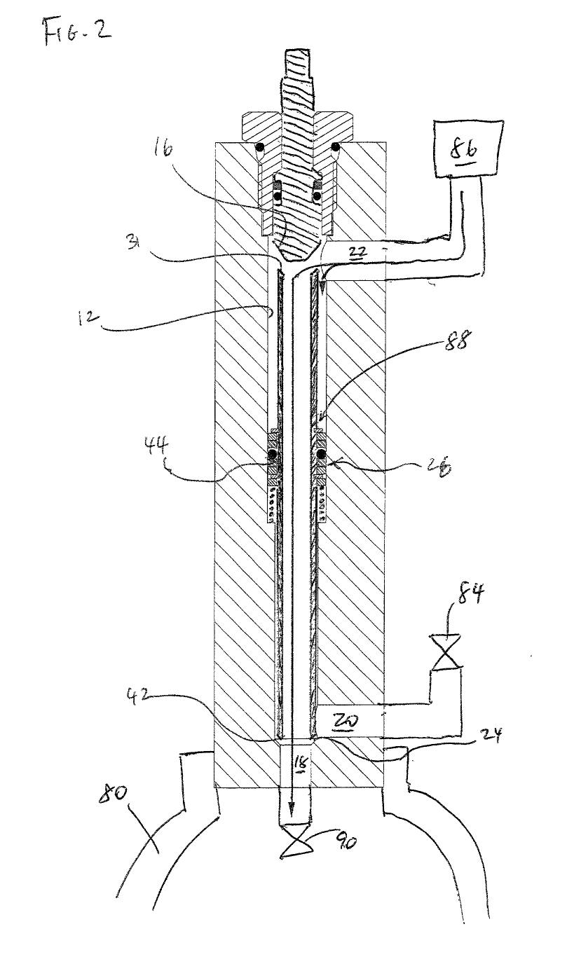

FIG. 2 illustrates the apparatus in a fill condition, whereby pressurized gas is supplied from a fill assembly 86 into the pressure vessel 80 via a flowpath through the third and first ports 22, 18. In this condition, the valve 16 characterized by a second valve position. In the second valve position, the valve 16 is, with respect to the first valve position, remote from the first port 18. Simultaneously, resilient member 54 urges the piston 14 in a direction towards the valve 16, and away from the first sealing surface 24. In operation, gas or a gaseous mixture flows through the third port 22 and presses upon a pressure responsive surface 88 presented by the piston 14, whereby the pressure responsive surface 88 is transverse to the longitudinal axis of the conduit 12. In the embodiment illustrated, the pressure responsive surface 88 includes the O-ring 72. Therefore, as gas or a gaseous mixture flows in through the third port 22, the pressure associated therewith urges the piston 14 away from the valve 16. As a result, the valve 16 is spaced apart from the second aperture 30, thereby ensuring fluid communication between the first port 18 and the third port 22 via the bore 34.

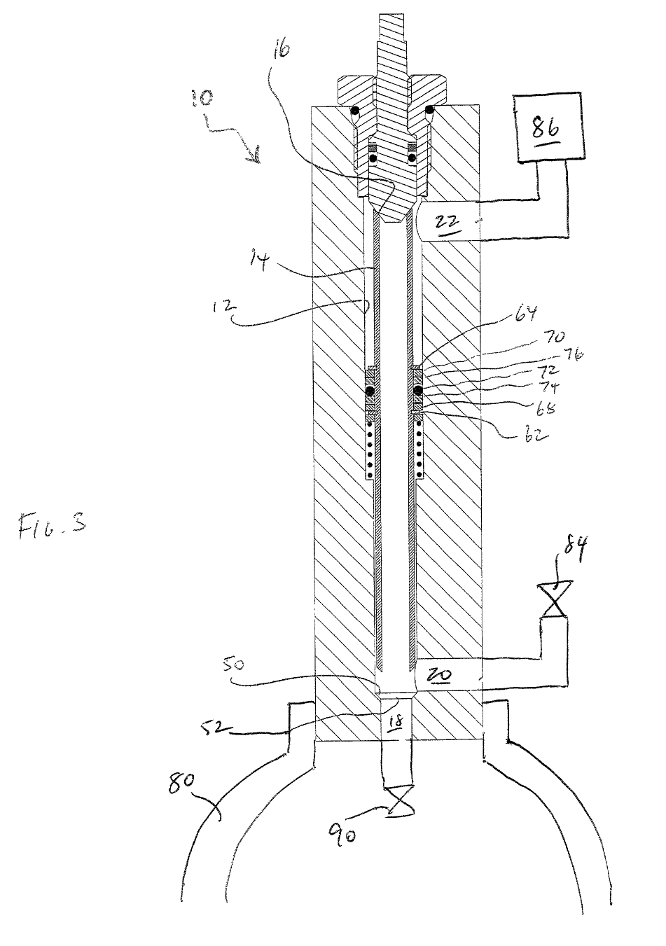

FIG. 3 illustrates the apparatus 10 in a supply condition. In this condition, fluid communication is established between the first port 18 and the second port 20, while the first port 18 is isolated from the third port 22. In this respect, the piston 14 is in the second piston position. The first piston valve surface 42 is spaced apart from the valve seat 50, thereby unsealing the second port 20. Simultaneously, the valve 16 is in the second valve position and seals the second piston aperture 30. Also, the second piston valve surface 44 is in sealing engagement with the second sealing surface 48. As a result, the third port 22 is isolated from each of the first and second ports 18, 20.

In operation, when it is desired to deliver a gas or gaseous mixture from the pressure vessel to the regulator 84 coupled to the second port 20 of the apparatus 10, an automatic bi-directional shut-off valve 90, such as a solenoid actuated valve disposed inside the vessel 80, is actuated to an open position, thereby facilitating pressurization of the first port 18 by exposure to vessel pressure through the shut-off valve 90.

Immediately prior to opening of the shut-off valve 90 to effect pressurization of the first port 18, valve 16 is characterized by the second valve position. As mentioned above, in the second valve position, the valve 16 is, with respect to the first valve position, remote from the first port 18. Simultaneously, the resilient member 54 urges the piston 14 in a direction towards the valve 16, and away from the first sealing surface 46. In this respect, immediately prior to opening of the shut-off valve 90, valve 16 is seated against valve seat 31, thereby closing second piston aperture 30. Because second piston aperture 30 is closed, and because second piston valve surface 64 is sealingly engaged to the second sealing surface 26, third port 22 is sealed from first port 18, thereby blocking communication between first port 18 and third port 22. Immediately after opening of shut-off valve 90, first port 18 becomes pressurized, and the gas or gaseous mixture flows through the first port 18, orifice 52, and into the second port 20. Simultaneously the gas or gaseous mixture fills the space between the second piston valve surface 44 and the first port 18. As such, gas pressure further urges piston 14 away from the first sealing surface 24. This helps to maintain the piston 14 in sealing engagement with the valve 16, thereby maintaining the third port 22 in a sealed condition and preventing any leakage through the third port 22.

Although the disclosure describes and illustrates preferred embodiments of the invention, it is to be understood that the invention is not limited to these particular embodiments. Many variations and modifications will now occur to those skilled in the art. For definition of the invention, reference is to be made to the appended claims.

1. A valve apparatus comprising:
a conduit, including a first port, a second port, and a third port;
a piston sealingly disposed within the conduit, including:
a first piston aperture and a second piston aperture;
a piston valve configured to seal the second port; and
a bore, extending from the first piston aperture to the second piston aperture, and configured to facilitate communication between the first port and the third port; and
a valve, disposed within the conduit, and configured to seal the third port.

2. The valve apparatus as claimed in claim 1, wherein the piston is sealingly disposed between (i) the first and second ports, and (ii) the third port.

3. The valve apparatus as claimed in claim 2, wherein the bore communicates with the first port.

4. The valve apparatus as claimed in claim 2, wherein the first piston aperture communicates with the first port.

5. The valve apparatus as claimed in claim 2, wherein the valve is configured to seal the second piston aperture to thereby seal the third port.

6. The valve apparatus as claimed in claim 2, wherein the piston is moveable, relative to the conduit, from a first piston position to a second piston position, and wherein the first port is isolated from the second port when the piston is in the first piston position, and wherein the first port is in communication with the second port when the piston is in the second piston position.

7. The valve apparatus as claimed in claim 6, wherein the first port is in communication with the third port when (i) the piston is in the first piston position, and (ii) the valve is spaced apart from the second aperture.

8. The valve apparatus as claimed in claim 7, wherein the first port is in communication with the third port via the bore.

9. The valve apparatus as claimed in claim 8, wherein the first port is isolated from the third port when (i) the piston is in the first piston position, and (ii) the valve seals the second piston aperture.

10. The valve apparatus as claimed in claim 9, wherein the first port is isolated from the third port when (i) the piston is in the second piston position, and (ii) the valve seals the second piston aperture.

11. The valve apparatus as claimed in claim 5, wherein the valve is moveable, relative to the conduit, from a first valve position to a second valve position, and wherein the piston is maintained in the first piston position when the valve is in the first valve position, and wherein the piston is moveable from a first piston position when the valve is in the second valve position.

12. The valve apparatus as claimed in claim 11, wherein the piston is moveable between a first piston position and a second piston position when the valve is in the second valve position.

13. The valve apparatus as claimed in claim 12, wherein the first port is in communication with the third port via the bore when (i) the piston is in the first piston position, and (ii) the valve is in the second valve position.

14. The valve apparatus as claimed in claim 13, wherein the first port is isolated from the third port when (i) the piston is in the first piston position, and (ii) the valve is in the first valve position.

15. The valve apparatus as claimed in claim 14, wherein the valve retains the piston in the first piston position when the valve is in the first valve position.

16. The valve apparatus as claimed in claim 15, wherein the valve is engaged to the piston when (i) the piston is in the first piston position, and (ii) the valve is in the first valve position.

17. The valve apparatus as claimed in claim 16, wherein the first port is in communication with the second port, and the first and second ports are isolated from the third port, when (i) the piston is in the second piston position, and (ii) the valve is in the second valve position.

18. The valve apparatus as claimed in claim 17, wherein the valve is configured to seal the second aperture to thereby seal the third port when the valve is in the second valve position.

19. A valve apparatus comprising:
a conduit, including a first port, a second port, a third port, a first sealing surface disposed between the first port and the second port, and a second sealing surface disposed between the second port and the third port;
a piston sealingly disposed within the conduit, including:
a first piston aperture and a second piston aperture;
a first piston valve surface configured to seal the first sealing surface;
a second piston valve surface configured to seal the second sealing surface; and
a bore, extending from the first piston aperture to the second piston aperture, and configured to facilitate communication between the first port and the third port; and
a valve, disposed within the conduit, and configured to seal the second piston aperture to thereby seal the third port.

20. The valve apparatus as claimed in claim 19, wherein the piston is sealingly disposed between (i) the first and second ports, and (ii) the third port.

21. The valve apparatus as claimed in claim 20, wherein the bore communicates with the first port.

22. The valve apparatus as claimed in claim 20, wherein the first piston aperture communicates with the first port.

23. The valve apparatus as claimed in claim 22, wherein the piston is moveable, relative to the conduit, from a first piston position to a second piston position, and wherein the first port is isolated from the second port when the piston is in the first piston position, and wherein the first port is in communication with the second port when the piston is in the second piston position.

24. The valve apparatus as claimed in claim 23, wherein the first port is in communication with the third port when (i) the piston is in the first piston position, and (ii) the valve is spaced apart from the second aperture.

25. The valve apparatus as claimed in claim 24, wherein the first port is in communication with the third port via the bore.

26. The valve apparatus as claimed in claim 25, wherein the first port is isolated from the third port when (i) the piston is in the first piston position, and (ii) the valve seals the second piston aperture.

27. The valve apparatus as claimed in claim 26, wherein the first port is isolated from the third port when (i) the piston is in the second piston position, and (ii) the valve seals the second piston aperture.

28. The valve apparatus as claimed in claim 22, wherein the valve is moveable, relative to the conduit, from a first valve position to a second valve position, and wherein the piston is maintained in the first piston position when the valve is in the first valve position, and wherein the piston is moveable from a first piston position when the valve is in the second valve position.

29. The valve apparatus as claimed in claim 28, wherein the piston is moveable between a first piston position and a second piston position when the valve is in the second valve position.

30. The valve apparatus as claimed in claim 29, wherein the first port is in communication with the third port via the bore when (i) the piston is in the first piston position, and (ii) the valve is in the second valve position.

31. The valve apparatus as claimed in claim 30, wherein the first port is isolated from the third port when (i) the piston is in the first piston position, and (ii) the valve is in the first valve position.

32. The valve apparatus as claimed in claim 31, wherein the valve retains the piston in the first piston position when the valve is in the first valve position.

33. The valve apparatus as claimed in claim 32, wherein the valve is engaged to the piston when (i) the piston is in the first piston position, and (ii) the valve is in the first valve position.

34. The valve apparatus as claimed in claim 33, wherein the first port is in communication with the second port, and the first and second ports are isolated from the third port, when (i) the piston is in the second piston position, and (ii) the valve is in the second valve position.

35. The valve apparatus as claimed in claim 27, wherein the first sealing surface comprises a valve seat including an orifice, and wherein the first port extends into the orifice.

36. The valve apparatus as claimed in claim 35, wherein the piston is moveable, relative to the conduit, from a first piston position to a second piston position, and wherein the first piston valve surface is sealingly engaged to the valve seat and the second piston valve is sealingly engaged to the second sealing surface when the piston is in the first piston position, and wherein the first piston valve surface is spaced apart from the valve seat and the second piston valve surface is sealingly engaged to the second sealing surface when the piston is in the second piston position.

37. The valve apparatus as claimed in claim 36, wherein the valve is moveable, relative to the conduit, from a first valve position to a second valve position, and wherein the piston is maintained in the first piston position when the valve is in the first valve position, and wherein the piston is moveable from a first piston position when the valve is in the second valve position.

38. A valve apparatus comprising:
a conduit, including a first port, a second port, a third port, and a radially extending shoulder;
a piston sealingly disposed within the conduit, including:
a first piston aperture and a second piston aperture;
a piston valve configured to seal the second port; and
a bore, extending from the first piston aperture to the second piston aperture and configured to facilitate communication between the first port and the third port;
a valve, disposed within the conduit, and configured to seal the third port; and
a resilient member, urging the piston to a position whereby the second port is unsealed.

39. The valve apparatus as claimed in claim 38, wherein the piston valve is biassed to a position whereby the second port is unsealed.

40. The valve apparatus as claimed in claim 39, wherein the resilient member includes a first end and a second end, and wherein the first end is supported by the shoulder and the second end is supported by the piston.

41. The valve apparatus as claimed in claim 40, wherein the shoulder is disposed, with respect to the second port, remote from the first port.

42. The valve apparatus as claimed in claim 40, wherein the shoulder is disposed between the second port and the third port.

43. The valve apparatus as claimed in claim 40, wherein the piston valve includes a first valve surface and a second valve surface, wherein the first valve surface is configured for sealing engagement with the conduit between the first port and the second port, and wherein the second valve surface is configured for sealing engagement with the conduit between the second port and the third port, and wherein the second end of the resilient member is supported by the second valve surface.

44. The valve apparatus as claimed in claim 43 wherein the second valve surface comprises a first retainer, a second retainer, and a deformable member, wherein the deformable member is disposed between the first retainer and the second retainer.

45. The valve apparatus as claimed in claim 44, wherein the deformable member comprises a first steel ring, a second steel ring, an o-ring, a first back-up o-ring, and a second back-up o-ring, wherein each of the o-ring, first back-up o-ring, and second back-up o-ring is disposed between the first steel ring and the second steel ring, and wherein the o-ring is disposed between the first back-up o-ring and the second back-up o-ring.
